(19) United States
(12) Patent Application Publication
(10) Pub. No.: US 2011/0106551 A1
(43) Pub. Date: May 5, 2011

(54) Tracking an Aircraft Engine

(75) Inventors: Dany Durand, Candiac (CA); Remi Poulin, Mont-Saint-Hilaire (CA)

(73) Assignee: Pratt & Whitney Canada Corp.

(21) Appl. No.: 12/612,045

(22) Filed: Nov. 4, 2009

(51) Int. Cl. G06Q 10/00

(52) U.S. Cl. 705/1.1

(57) ABSTRACT

Methods, systems, and apparatus for tracking aircraft engines are provided, wherein an engine has an engine log book associated therewith. Disclosed methods comprise receiving from at least one device attached to the log book one or more signals representative of a location of the log book; using the signal representative of the location of the log book to determine a location of the engine and storing in memory readable by the same or another data processor signals representative of the location of the engine.

### TECHNICAL FIELD

The disclosure relates generally to the tracking of engines, for maintenance and other purposes, and more particularly to the tracking of an aircraft engine via a log book associated with the engine.

### BACKGROUND OF THE ART

Aircraft engines are assets which may be leased to customers for powering their aircraft. It is desirable to track such engines, for example, to determine their locations. Manual tracking of engines is time consuming, and prone to error. Electronic tracking, such as by attaching automatically trackable devices to the engines is problematic, since such devices may cause electromagnetic interference which interfere with the engine or aircraft operation. Further, the operational conditions associated with such aircraft engines, such as vibration, heat, etc, make typical electronic tracking devices unsuitable for the implementation of a robust tracking system.

Room for improvement therefore exists.

### SUMMARY

The disclosure herein describes methods, systems, and apparatus, including suitably-configured computer programming devices, for tracking aircraft engines using associated log books.

For example, in various embodiments the invention provides such methods, comprising receiving from at least one device attached to a log book associated with an aircraft engine one or more signals representative of a location of the log book; using the signal representative of the location of the log book, determining a location of the engine; and storing in memory readable by the same or another data processor signals representative of the location of the engine. Data so stored can further be used for other processes, including for example to identify an operator of the engine, to determine whether the engine is mounted on an aircraft, to identify an aircraft upon which such an engine is mounted, and/or to schedule or otherwise control maintenance of the engine.

Further details of these and other aspects of the subject matter of this application will be apparent from the detailed description and drawings included below.

### DESCRIPTION OF THE DRAWINGS

Reference is now made to the accompanying drawings, in which:

FIG. 1 is an isometric view of a log book assembly comprising a tracking device according to one embodiment;

FIG. 2 is a schematic representation of the tracking device of FIG. 1.

FIG. 3 is a flow chart representation of a method of tracking an engine using the log book assembly of FIG. 1.

### DETAILED DESCRIPTION

Various aspects of the present approach are described through reference to the drawings and the following description.

It is well understood that airworthiness regulations, such as those administered by the Federal Aviation Authority (FAA), Transport Canada and other national and regional authorities, require engine operation and maintenance activity to be recorded as a condition of the continued airworthiness of the aircraft engine. See, for example, the Federal Aviation Regulations (e.g. 14 CFR 91-417) and the Canadian Aviation Regulations (e.g. s.605.92 and TP 14182), both of which are incorporated herein, by reference, in their entireties. Among the ways in which the mandated technical records are maintained, one of the more popular is to record the required information in a multi-paged book (typically hard-covered), known variously as an engine log or log book, engine maintenance log, engine technical log book, etc. (referred to hereinafter in the description and claims as a “log book”). Example commercially-available log books are the Aviation Supplies & Academics, Inc. (ASA) Engine Logs, #ASA-SE-1 and #ASA-SE-2. Typically, an engine's log book accompanies the engine wherever the engine goes—that is, when the engine is mounted on the aircraft, the log book is onboard the aircraft, and when the engine is in a shipping container (e.g. when originally shipped from the manufacturer, or when removed from the aircraft to shipping to an overhaul shop or to be temporarily stored, etc.) the log book is also placed in the shipping container with the engine.

According to an aspect of the present method and system, the inventors have found that the engine location may be automatically tracked by automatically tracking the location engine log book rather than the engine itself, as will now be further described.

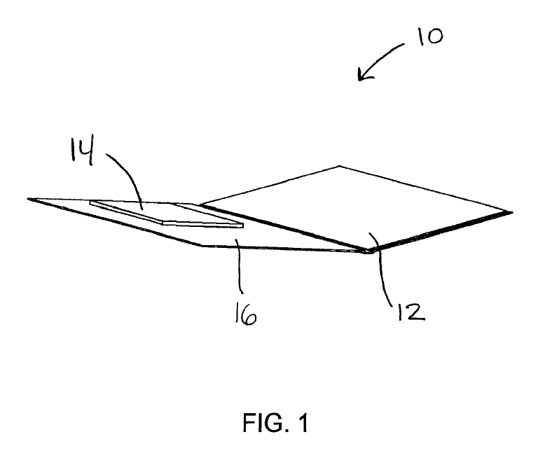

FIG. 1 illustrates a log book assembly 10 used to provide usage, maintenance, and/or other records associated with a particular aircraft engine (not shown). Log book assembly 10 comprises log book 12 associated with the engine and tracking device 14. Log book 12 may be of any type suitable for use in implementing the disclosure herein, including any otherwise conventional type used for recording operational information of an aircraft engine. For example, operational information recorded in log book 12 may include the configuration of the engine, number of hours in operation, number of cycles, and details of any maintenance performed or scheduled to be performed on the engine.

Tracking device 14 may be attached to or otherwise selectively fixedly disposed proximate to log book 12, so that the transmitted location of tracking device 14 is representative of the location of log book 12. Tracking device 14 may be attached to log book 12 in any manner compatible with the purposes disclosed herein, including for example any currently known conventional manners, including for example gluing or otherwise mechanically affixing to, or embedding within, any portion of cover 16 or other portion of the log book 12, including any page(s) thereof.

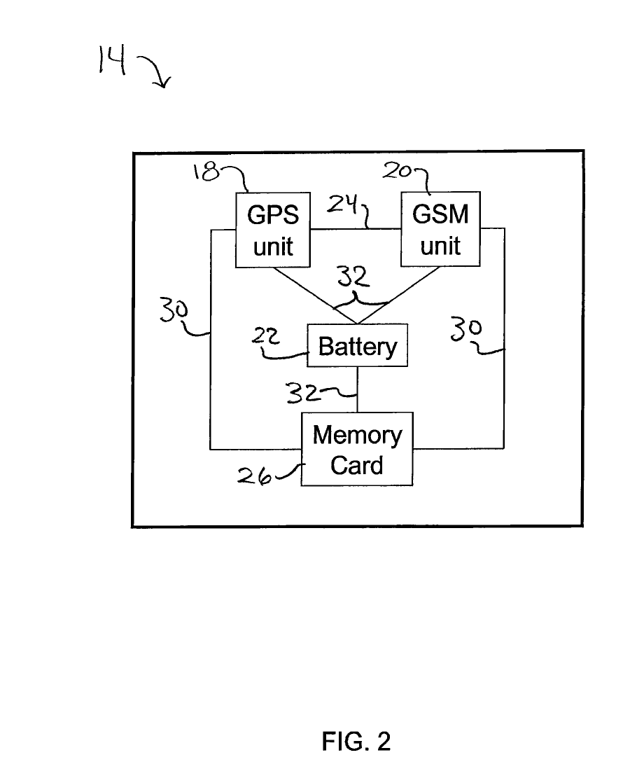

FIG. 2 schematically illustrates various components, any one or more of which may be included in various embodiments of tracking device 14. For example, tracking device 14 may comprise global positioning system (GPS) unit 18; global system for mobile communications (GSM) unit 20; battery, solar chip, or other power supply 22; and memory(ies) 26, any or all of which may comprise any necessary or desired processors, communications subsystems, data buses or other components or supporting hardware or firmware. GPS unit 18 may for example comprise a conventional GPS receiver configured to receive GPS signals from GPS satellites (not shown) and determine its geographic location according to conventional methods. GSM unit 20 may also be of conventional type and may be operatively connected to GPS unit 18 via link 24. GSM unit 20 may be configured to wirelessly transmit a signal representative of the geographic location determined by GPS unit 18. GSM unit 20 may also be configured to receive data wirelessly.

Memory(ies) 26 may comprise any suitable volatile or persistent memory devices, including for example one or more memory cards 26. One or more such memories 26 may be integrated as part of tracking device 14. Memory card 26 may operate as an information storage device and may be operatively coupled to GPS unit 18 and GSM unit 20 via links 30. GSM unit 20 and memory card 26 may be configured so that GSM unit 20 is able to transmit information stored on memory card 26 and so that GSM unit 20 is also able to receive information and have the information stored on memory card 26. It is understood that other components such as a processor connected to GPS unit 18 and GSM unit 20 and circuitry not shown or described here may be included in tracking device 14. Battery 22 may be configured to serve as a suitable power source for the operation of GPS unit 18, GSM unit 20 and memory card 26 via links 32.

Log book assembly 10 may be used to indirectly track an engine associated with log book assembly 10. Unlike conventional asset tracking methods, the tracking of the engine may be conducted via log book assembly 10 without requiring tracking device 14 to be installed directly to the engine. The engine may be an aircraft or other engine such as a gas turbine engine (not shown) which may be in operation and mounted to an aircraft or other vehicle (not shown). Alternatively, the engine may be in storage, being transported, or be removed from the aircraft for other reasons such as maintenance for example. For gas turbine engines used in aircraft applications, the use of a log book is typically considered critical for maintenance and compliance with regulatory requirements, and the engine often cannot be sold, operated, maintained or reduced to spare parts without the presence and proper upkeep of a log book for traceability purposes. When the engine is not mounted to the aircraft, log book assembly may be kept together with the engine most or all of the time. For the case of an aircraft engine in storage, log book assembly 10 may be kept in the engine cradle together with the engine.

When the engine is in use or otherwise mounted to an aircraft, log book assembly 10 may or may not be kept together with the engine due to installation restrictions, regulations, and/or other requirements. For an aircraft engine, it may not be practical to keep log book assembly 10 with the engine during use due to potential electromagnetic interference (EMI) and/or challenges associated with isolating log book assembly 10 from vibrations, temperature variations and weather. Other concerns may also include added weight and certification requirements of the engine. Accordingly, when the engine is mounted to an aircraft, log book assembly may be located at an operator's maintenance or other facility. The operator may be an airline company for example.

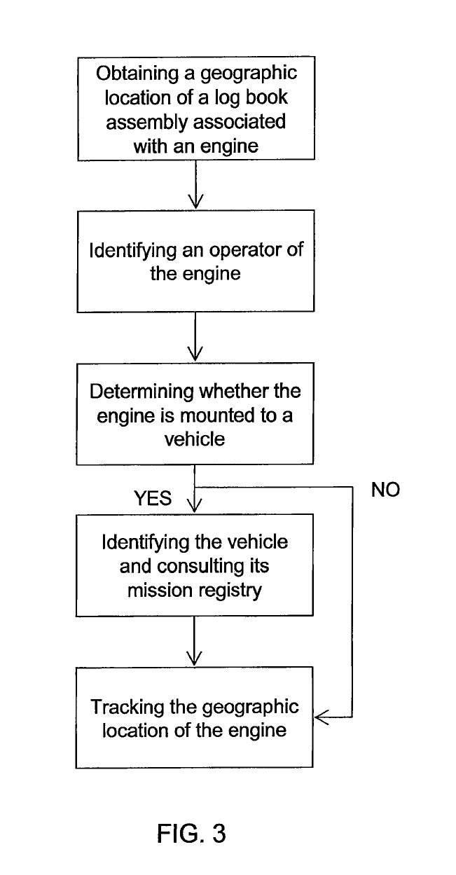

FIG. 3 schematically illustrates an exemplary method which may be used to track an engine using log book assembly 10. Such a method may be implemented using suitably-configured data processing equipment operated by, for example, a manufacturer, a retailer, lessor, operator, and/or contract maintenance service of the engine who may be interested in tracking the engine for the purpose of obtaining the geographic location of the engine, establishing or consulting a maintenance schedule for the engine or obtaining other information related to the operation of the engine. For example, a networked computer system operated by an authorized and interested party using conventional signal processing equipment (not shown) may receive a signal representative of the geographic location of log book assembly 10 transmitted via tracking device 14. For example, a global position determined using GPS 18 may be wirelessly transmitted via GSM unit 20 at an airport terminal or apron to a receiver associated with an operator computer terminal.

Further information associated with the engine and stored in memory(ies) 26 may also be provided to and/or received the operator of the computer system. Such information can, for example, include an operational status, a maintenance schedule, flight and/or other operating use information, and can be processed by the networked computer system before and/or after storage on the memory(ies) 26. Information can also be stored in memory(ies) 26 by personnel using the log book at time of maintenance, etc., using suitably-adapted input/output components interfaced with device 14. The provision of suitable input/output components will not trouble those skilled in the relevant arts, once they have been made familiar with this disclosure.

An example of a use of the geographic location of a log book assembly 10 to identify an operator, contractor, or other party in custody or control of an engine would be the geographic correlation of the locations of the engine and the party in such custody or control. With the identity of such operator, the operator may be contacted to determine whether the engine is mounted to a vehicle. If the engine is mounted to a vehicle, the operator may provide the identity of the vehicle onto which the engine is mounted. For example, an airline company may provide the interested party with the registration number of the aircraft of interest. The geographic location of the aircraft engine may then be obtained indirectly based on the mission registry of the aircraft of interest. The information required from the operator of the engine may be obtained automatically and electronically from a database using conventional data sharing and user authentication methods through a web portal for example.

In some applications, it may not be necessary to obtain the exact geographic location of the engine. For example, it may be sufficient to simply determine whether the engine is mounted to a vehicle or if the engine is in storage.

Memory card 26 may be used by an operator, contractor, or other party to store information relating to the operation and maintenance of the engine. For example, information stored on memory card may include information of the same type that would normally be recorded in log book 12. Also, since GSM unit 20 may be configured to transmit and receive information, information may be transmitted to and retrieved from memory card 26 wirelessly via GSM unit 20.

In addition to or instead of tracking the geographic location of an engine via log book assembly 10, tracking of the engine may include receiving information relating to the operation and maintenance of the engine. Such information may be used for the purpose of determining and/or implementing a maintenance schedule for the engine. In some cases the exact, geographic location of the engine may not be required. However, in some cases, it may be useful to additionally obtain or track the geographic location of the engine via its mission registry to determine the climate in which the engine was exposed and forecast a maintenance schedule accordingly.

The above description is meant to be exemplary only, and one skilled in the art will recognize that changes may be made to the embodiments described without departing from the scope of the invention disclosed. For example, log book assembly 10 may contain sensors which may be used to put constraints on the operability of log book assembly 10. For example, sensors may be configured to detect tampering with the log book and send a suitable signal upon such detection. Also, it is apparent that another type of wireless communication unit such as, for example, GPRS (General Packet Radio Service) could also be used instead of or in addition to GSM unit 20. Any suitable automatic tracking system may be used, and the skilled reader will recognize that the present approach is not limited to the specific example technologies presented in the exemplary embodiments presented herein. Still other modifications which fall within the scope of the present invention will be apparent to those skilled in the art, in light of a review of this disclosure, and such modifications are intended to fall within the appended claims.

What is claimed is:

1. A method for tracking an aircraft engine, the engine having an engine log book associated with the engine, the method performed by a data processor and comprising:
receiving from at least one device attached to the log book one or more signals representative of a location of the log book;
using the signal representative of the location of the log book, determining a location of the engine;
storing in memory readable by the same or another data processor signals representative of the location of the engine.

2. The method as defined in claim 1, comprising using data stored in memory to identify an operator of the engine.

3. The method as defined in claim 2, comprising reading data related to the operator of the engine to determine whether the engine is mounted to an aircraft.

4. The method as defined in claim 2, comprising reading data related to the operator of the engine to identify an aircraft to which the engine is mounted.

5. The method as defined in claim 4, comprising reading data associated with a mission registry of the aircraft.

6. The method as defined in claim 1, comprising using data received from the device attached to the log book to schedule maintenance of the engine.

7. The method as defined in claim 1, comprising using data received from a device attached to the log book to track a geographic location of the engine.

8. A method performed by a data processor for tracking an aircraft engine, the method comprising:
receiving a signal representative of a location of the log book from a tracking device attached to a log book of the engine;
determining a location of the engine based on the signal representative of the location of the log book; and
storing a location of the engine in memory readable by the same or another data processor.

9. The method as defined in claim 8, comprising identifying an operator of the engine based on the signal representative of a location of the log book.

10. The method as defined in claim 9, comprising using data received from an operator to determine whether the engine is mounted to an aircraft.

11. The method as defined in claim 9, comprising using data received from an operator to identify an aircraft to which the engine is mounted.

12. The method as defined in claim 8, comprising receiving from the tracking device attached to the log book, a signal useful in scheduling maintenance of the engine.

13. A system for tracking an airworthy aircraft engine, the assembly comprising:
an engine log book of the engine; and
a tracking device attached to the log book and configured to determine and transmit a location of the log book.

14. The system as defined in claim 13, comprising a data processor configured to receive from the tracking device a signal representative of the location of the log book.

15. The system as defined in claim 13, wherein the tracking device comprises a GPS receiver.

16. The system as defined in claim 13, wherein the tracking device comprises a wireless transmitter.

17. The system as defined in claim 16, comprising a storage device operatively coupled to the wireless transmitter.

18. The system as defined in claim 15, wherein the tracking device comprises a GSM unit.

19. The system as defined in claim 18, wherein the tracking device is attached to a cover of the log book.

20. The system as defined in claim 19, wherein the tracking device comprises a memory card adapted to store information related to the engine.
